(19) United States
(12) Patent Application Publication
(10) Pub. No.: US 2004/0093380 A1
(43) Pub. Date: May 13, 2004

(54) Diary system

(76) Inventors: Abigail Jane Sellen, Newbury (GB); Andrew Dudley Morgan, Bishop Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/312,329

(22) PCT Filed: Apr. 26, 2002
(86) PCT No.: PCT/GB02/01956

(30) Foreign Application Priority Data
Apr. 28, 2001 (GB) 0110442.1

(51) Int. Cl. G06F 15/16

(52) U.S. Cl. 709/204

(57) ABSTRACT

A method of sharing diary events between electronic diaries involves a first electronic diary on a first computing device and a second electronic diary on a second computing device. A collection of diary events is formed on the first electronic diary as a representation of the first electronic diary. Sharing is accomplished by establishing communication between the first electronic diary and the second electronic diary and sending the representation of the first electronic diary from the first computing device to the second computing device for comparison with the second electronic diary.

### FIELD OF INVENTION

The present invention relates to a system, a mobile computing device and a method for enabling people to schedule and keep track of daily events with others. In particular the system comprises devices and software for enabling people to schedule daily events with each other.

### PRIOR ART

Within groups of people, for example within companies or within families, individuals will each have their own set of daily events to record. These daily events may be recorded in paper diaries, or on electronic diaries, for example on fixed computing devices based at work or at home, such as personal computers, or on mobile computing devices, such as hand held electronic personal organisers, which are sometimes combined with mobile phones. The synchronisation of diaries within the group can be a cumbersome and time consuming task.

The underlying principle currently involved in the management of daily events scheduling within groups, requires a central computing device to act as a central repository for recording daily events. This client-server relationship defines the architecture of the software that implements the management of the data between the individual work diaries of the people within the group.

### SUMMARY OF INVENTION

In a first aspect, the invention provides a computing device programmed with a diary system application, the computing device comprising a processor, a memory, a user interface and a communications interface, wherein the processor ruining the diary system application allows a user to assign through the user interface one or more diary events stored in the memory to one or more categories; and wherein the processor running the diary system application allows or disallows communication to other devices through the communication interface of diary events on the basis of the category or categories to which the diary events have been assigned.

In a second aspect, the invention provides a portable computing device programmed with a diary system application, the computing device comprising a processor, a memory, a user interface, a display and a wireless transmitter adapted for short range communication, wherein the processor running the diary system application allows a user to view a user diary on the display, assign through the user interface one or more diary events stored in the memory to one or more categories; and wherein the processor running the diary system application allows or disallows communication to other devices through the wireless transceiver of diary events in one or more of said categories on the basis of the category or categories to which the diary events have been assigned.

In a third aspect, the invention provides a method of sharing diary events between electronic diaries, comprising:

assigning one or more diary events stored in a first electronic diary, operating on a first computing device, to one or more categories;

assigning for at least one of said one or more categories a sharing status which allows diary events in said at least one category to be shared with at least a second electronic diary, operating on a second computing device;

establishing communication between the first electronic diary and the second electronic diary; and

sending one or more diary events in said at least one category from the first electronic diary to the second electronic diary.

In a fourth aspect, the invention provides a method of sharing diary events between electronic diaries, comprising:

creating a first electronic diary on a first computing device;

creating a second electronic diary on a second computing device;

forming a collection of diary events on the first electronic diary as a representation of the first electronic diary;

establishing communication between the first electronic diary and the second electronic diary; and

sending the representation of the first electronic diary from the first computing device to the second computing device for comparison with the second electronic diary.

In a fifth aspect, the invention provides a computer program product on a data carrier, a processor programmed with the computer program product having the following functions:

maintaining a user diary comprising a plurality of diary events;

enabling diary events to be assigned to one or more sharing categories, each sharing category having a sharing status; and

sharing the diary events in said one or more sharing categories in accordance with the sharing status of that sharing category.

In preferred embodiments of aspects of the invention, users of mobile computing devices on entering the same vicinity are able to generate a local communication link between each other's mobile computing devices in order to directly share diary data with each other either to update each other's diary data or to facilitate the scheduling of a meeting at a mutually convenient time.

The diary data stored and displayed on the mobile computing device and communicated over the local communication link according to the present invention represents a set of events over a predetermined time period. The set of events will be events that have been input into the event scheduling application either directly by the user of the mobile computing device or indirectly from another computing device by a diary data transfer of the types which are discussed below. The diary data comprises a set of events recorded in the event scheduling application over a predetermined period of time, such as a day (24 hours), a working day (eg. 8 a.m. to 6 p.m.), a week or a working week (eg. Monday to Friday 8 a.m. to 6 p.m.).

The local communication link may be a physical connection formed between mobile computing devices to directly communicate diary data.

Alternatively, the local communication link may be a local wireless connection between mobile computing devices to directly communicate diary data. The wireless connection may be a short range radio wireless connection, for example using Bluetooth technology or alternatively could be a short range infrared wireless connection, for example using IrDA technology.

For example, where Bluetooth technology is used, it is possible to form automatically a wireless connection to communicate diary data directly between associated mobile computing devices. The automatic connections may be formed at predetermined time intervals. Alternatively, the automatic connections may conveniently be formed each time the associated mobile devices enter each other's vicinity, ie. when they come into each other's local communication range. Such automatic communication of diary data can facilitate regular updating of the diary data in a set of associated mobile computing devices. For example, mobile computing devices belonging to different members of a family can be arranged to automatically update each other so that each family member is up to date with the events involving themselves and other family members.

In a preferred embodiment each mobile computing device comprises a memory unit for storing diary data and a display screen for displaying diary data. For facilitating the sharing of diary data in order to schedule a meeting, it is preferred that the event scheduling application of a first of the mobile computing devices includes an overlay sub-system for receiving diary data from the memory unit of the first mobile computing device and for receiving diary data of a second of the mobile computing devices directly over a local communication link and for preparing an overlay display comprising an overlay of a diary display generated from the diary data of the first computing device and a diary display generated from the diary data of the second computing device and displaying the overlay on the display screen of the first mobile computing device. If each mobile device prepares such an overlay, then the users of the devices can view the overlays to locate time slots in which neither of the users of the devices has an event previously scheduled.

In a preferred embodiment, the system according to the present invention additionally includes a fixed computing device on which is run an event scheduling control application for storing and displaying diary data and which is compatible with the event scheduling application run on the mobile computing devices wherein the control application includes a data sub-system for acting as central repository for the diary data of the mobile devices. In this embodiment it is preferred that the event scheduling applications running on the fixed computing device and each mobile computing device comprise a docking subsystem for enabling each of the mobile computing devices to transfer diary data to the fixed computing device for storage in the central repository for the diary data.

The system may additionally include a diary display device connected to the fixed computing device on which diary display device is run an event scheduling application for storing and displaying diary data and which is compatible with the event scheduling applications run on the mobile and fixed computing devices and the diary display device comprises a screen for displaying the diary data stored in the central repository for the diary data. The diary display device is preferably a simple thin liquid crystal display device which can be located in a communal area where it can be easily viewed. Preferably, to facilitate frequent transfer of diary data to the central repository of diary data stored on the fixed computing device, the application running on the diary display device additionally includes a communication sub-system for enabling the diary display device to communicate directly with mobile computing devices over a local communication link to communicate diary data. The local communication link may be physical or wireless, and if it is wireless it may be user initiated or automatic as described above.

In a further preferred embodiment of the system including the fixed computing device at least one of the mobile computing devices is a mobile telephone which communicates over a telecommunications network with the fixed computing device to update its diary data before communicating directly to share diary data with other of the mobile computing devices. This ensures that the diary data communicated by this mobile computing device is always up to date.

Preferably, the event scheduling application of the mobile computing devices enable events input into the application to be allocated to different categories of diary data and includes a privacy system for restricting the communication of selected categories of diary data to selected other devices. In a preferred embodiment the privacy system allows only the time slots associated with the selected categories of diary data to be communicated.

### DESCRIPTION OF DRAWINGS

In order that the present invention is more fully understood and to show how the same may be carried into effect, reference shall now be made, by way of example only, to the accompanying figures, wherein:

FIG. 1A shows two mobile computing devices running the event scheduling application according to an embodiment of the present invention which have direct wireless connectivity to share diary data;

FIG. 1B shows two mobile computing devices running the event scheduling application according to an embodiment of the present invention which can be directly physically connected to share diary data;

FIG. 1C shows the functional elements of one of the mobile computing devices illustrated in FIG. 1A;

FIG. 2 shows a system according to an embodiment of the present invention including a fixed computing device which acts as a central repository for diary data for a group of mobile computing devices such as are shown in FIGS. 1A and 1B and a display device for displaying the central repository of diary data;

FIG. 3 shows a system according to an embodiment of the present invention including a host server in a LAN which acts as a central repository for diary data for a group of mobile computing devices such as are shown in FIGS. 1A and 1B which can be docked to fixed computing devices in the LAN;

FIG. 4 shows a system similar to that shown in FIG. 3 except that the mobile devices are mobile phones which connect to the host server for an update of diary data before sharing diary data;

FIG. 5 shows a system similar to that shown in FIG. 2 except that the mobile devices are mobile phones which connect to the fixed computing device for an update of diary data before sharing diary data;

FIG. 6A shows a display showing diary data for a selected period with timeslots associated with existing appointments highlighted and the text giving details of the appointments deleted;

FIG. 6B shows a display showing diary data for a selected period with timeslots associated with existing appointments highlighted and showing the text giving details of the appointments;

FIG. 6C shows an overlay or a composite display of the displays shown in FIGS. 6A and 6B (with all text deleted) which is created on the screens of the mobile computing devices according to the present invention;

FIG. 7 shows a flow diagram of the steps involved in sharing diary data between the mobile devices of FIGS. 1A to 5 for facilitating the scheduling of a meeting;

FIG. 8 shows a flow diagram of the steps involved in sharing diary data between the mobile and fixed devices of FIGS. 1A to 5 for facilitating updating of the diary data stored in the devices; and

FIG. 9 shows a flow diagram of the steps involved in updating diary data in a mobile device over a telephone link to a computing device or host server incorporating a central repository of diary data in accordance with FIGS. 5 and 6.

### DESCRIPTION OF SPECIFIC EMBODIMENTS

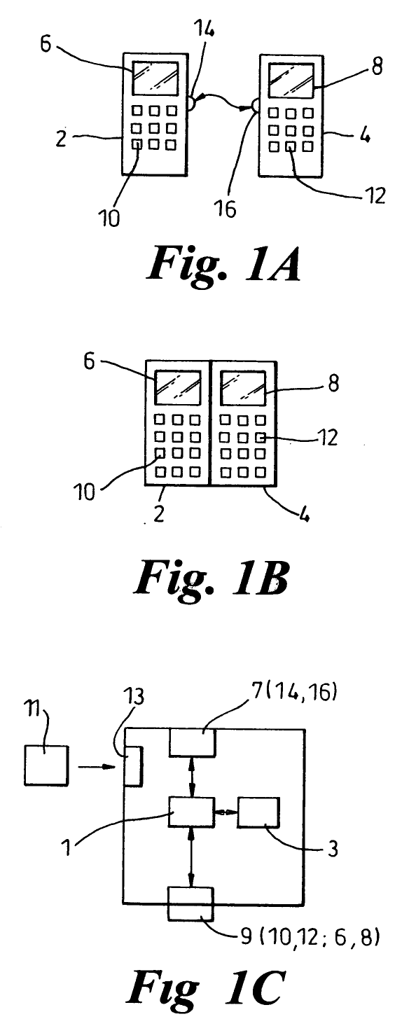

As will be discussed below, aspects of the present invention are particularly relevant to the exchange of diary information between users of mobile computing devices. There is a great diversity of mobile computing devices that people carry with them to help to organise their time and remind them of future actions. Examples include dedicated electronic organisers, mobile phones with calendar functionality, and Personal Digital Assistants (PDAs). In each of FIG. 1A and FIG. 1B is shown two such mobile hand held computing devices (2, 4) that each run a daily event scheduling application according to embodiments of the present invention. Diary data can be input into such devices, for example using a keyboard (10, 12) incorporated into the device or using electronic pen entry (not shown).

The basic functional elements of a computing device relevant to the present invention are shown in FIG. 1C. A processor (1) runs applications such as the event scheduling application, or electronic diarying application, according to embodiments of the present invention. Data, such as diary events and other diary data and also the application itself, is stored in a memory (3) in communication with the processor (1). Also in communication with the processor (1) is a communications interface (7)—in some aspects of the invention this may be a short range communications interface (14, 16) for local communication, but in other aspects other forms of communication interface (LAN, WAN, PSTN, cellphone network) may be used. Elements of a user interface (9)—these may comprise displays (6, 8) and keyboards (10, 12)—are also in communication with the processor (1).

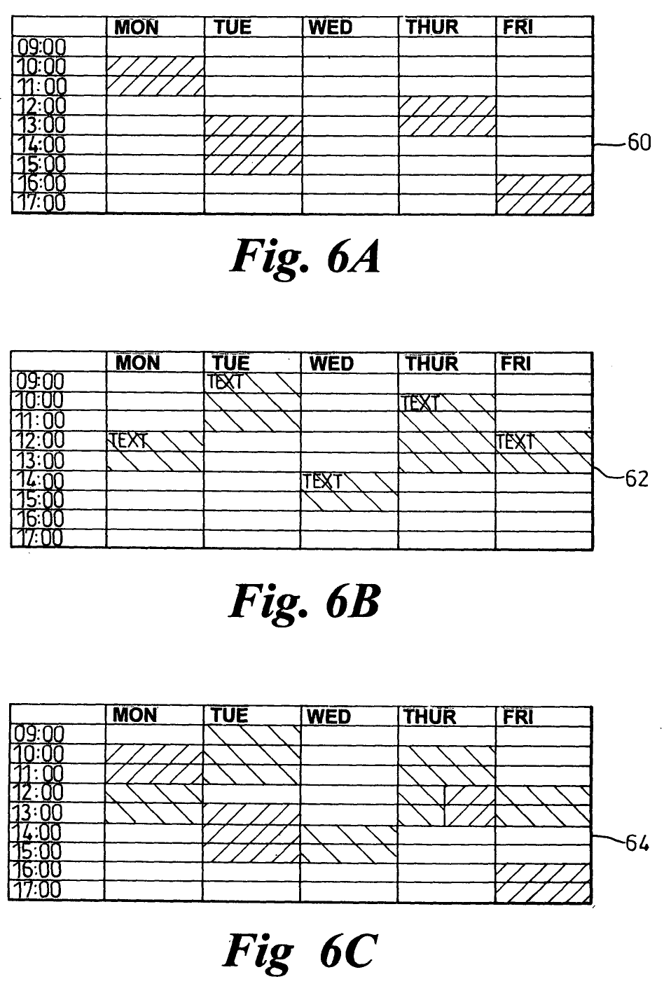

A display is created by the application which shows a sequence of time slots, each slot indicating a time of day for a particular day and date. New appointments are added by entering details of the appointment in the time slot representing the time at which the appointment will be, for example using the keyboards (10, 12) of the computing devices (2, 4). The display appears on the screen (6, 8) of the mobile computing device and shows daily events already recorded in the relevant time slots. The start time for each appointment and the end time for each appointment are marked on the display in association with a text giving details of the appointment. For example, an area of the display representing the time between the start time and end time for the meeting may be highlighted, for example by shading or colouring and the text giving details of the appointment may appear within the highlighted area. This is shown schematically for a sequence of one hour time slots within a working week in FIG. 6B.

When a user inputs an event into the event scheduling application, the event is allocated to one of a number of categories. For example, it can be allocated to a category of information which is only to be shared with selected other users. For example, where the event is of a personal nature, then the user may select to share information regarding the nature of the event with family members only and may not wish to share such information with work colleagues. Also, where the event is work related, then the user may select to share information regarding the nature of the event with work colleagues only and may not wish to share such information with users who work for other companies. Each such category of information would have associated with it a set of users with which that category of information can be shared. The categories of information and the associated users could, for example, be input into the mobile computing device when the event scheduling application is first set up on the computing device. The categories and associated users could the be updated periodically. The selected users could, for example, be identified in some way by the identification of their computing devices. A preferred approach to this would be by authentication of the selected user's computing devices. Any conventional (or other) approach to authentication, such as the use of encryption with a public key/private key pair, can be employed. It is particularly appropriate to use a challenge/response routine. There exist many available challenge/response mechanisms. An appropriate authentication protocol is mutual (or 3-step) authentication, as described in ISO/IEC 9798-3, “Information technology—Security techniques—Entity authentication mechanisms; Part 3; Entity authentication using a public key algorithm”, International Organization for Standardization, November 1993. Other acceptable authentication procedures, for example 2-step or 4-step, are also described in this reference. Procedures which do not involve a public key infrastructure can also be employed. It is also possible that the authentication may be of a user (who is, for example, required to identify himself or herself by password before being allowed to receive diary data), or may be of a user's smart card which can be used together with a range of different “receiving” devices.

Thus it can be seen that in one aspect the invention does provide a computing device (2) which is programmed with a diary system application. The computing device comprises a processor (1), a memory (3), a user interface comprising keyboard (10) and display (6) and a communications interface (14), in the FIG. 1A case for local communication but in other embodiments for remote communication. The processor (1) running the diary system application allows a user to assign through the user interface one or more diary events stored in the memory to one or more categories. The processor running the diary system application also allows or disallows communication to other devices through the communication interface (14) of diary events on the basis of the category or categories to which the diary events have been assigned.

It can also be seen that in a further aspect the invention provides a portable computing device (2) programmed with a diary system application. The computing device comprises a processor (1), a memory (3), a user interface (10) together with a display (6) and a wireless transmitter (14) adapted for short range communication. The processor running the diary system application allows a user to view a user diary on the display (6) and assign through the user interface (10) one or more diary events stored in the memory to one or more categories. The processor running the diary system application allows or disallows communication to other devices through the wireless transceiver of diary events in one or more of said categories on the basis of the category or categories to which the diary events have been assigned.

Such an event scheduling or diary application can be provided for loading on to the computing device in a number of ways—one approach is by providing the application on a media carrier (11) for which the computing device has a media carrier interface (13)—shown in FIG. 1C, or by download to the computing device from the server or from another computer to which it can establish a network connection.

It can thus be seen that in a further aspect the invention provides a computer program product on a data carrier (11), a processor programmed with the computer program product having the following functions: maintaining a user diary comprising a plurality of diary events; enabling diary events to be assigned to one or more sharing categories, each sharing category having a sharing status; and sharing the diary events in said one or more sharing categories in accordance with the sharing status of that sharing category.

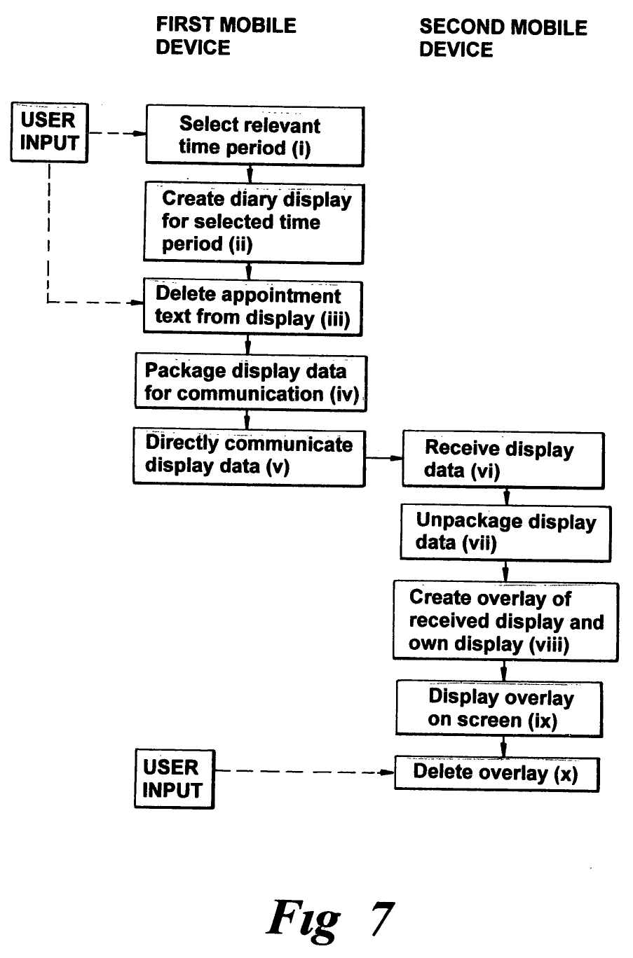

The users of the mobile computing devices (2, 4) come face to face with each other and decide to schedule a meeting together. This is done following the steps set out in the flow chart of FIG. 7. Each user activates a communication sub-system in the event scheduling application of their computing devices (2, 4). Referring first to the computing device (2), firstly a relevant time period is selected (box (i) of FIG. 7). The time period could be selected to be a period of days agreed with the user of the computing device (4) and input manually into the mobile device (see optional user input to box (i) of FIG. 7). Alternatively, the mobile computing device could automatically select a period of days, for example a week, beginning with the current day. The user of the device (2, 4) may also be able to stipulate whether time slots relevant to work time only or relevant to leisure time only or all time slots are to be selected. For example, if it is Sunday and the user of the computing device (2) stipulates work time slots only and the device is automatically set to select a period of a week hence, then a display would be created showing working days only within the next week, ie. Monday to Friday and working hours only, eg. 09:00 to 17:00 (box (ii) of FIG. 7).

Assume that the users of the devices (2, 4) are from competitor companies and so the user of the device (4) is not included on any lists of users with which the details of the diary data stored in the device (2) is to be shared. The communication sub-system of the device (2) then automatically deletes the text giving the details of various appointments within the week (box (iii) of FIG. 7) so that the display (60) would be as shown in FIG. 6A. Alternatively, the deletion of the text may be in response to a user input (see optional user input to box (iii) of FIG. 7), depending on whether the user wishes to keep confidential from the other user the nature of the appointments

The diary data making up the display for the selected period with the appointment text deleted is then packaged for transmission (box (iv) of FIG. 7) and is then directly communicated to the mobile device (4) (box (v) of FIG. 7). This communication between the device (2) and the device (4) can be supported using local wireless connectivity between the two devices (2, 4), for example using Bluetooth connectivity at radio frequency or IrDA connectivity at infrared frequency as shown in FIG. 1A or by physically connecting the two devices, as shown in FIG. 1B. Where a wireless connection is used, each of the mobile computing devices would comprise a wireless transceiver module (14, 16) for forming the local communication link.

The computing device (4) similarly prepares a display (62), for the selected period, with the text relating to appointments deleted, for example as shown in FIG. 6B (but with the text deleted) and directly communicates this to the computing device (2), again using the IrDA or Bluetooth wireless connectivity or the physical connection.

It can thus be seen that in one aspect, the invention provides a method of sharing diary events between electronic diaries. A first step is the assigning of one or more diary events stored in a first electronic diary, operating on a first computing device, to one or more categories. This is followed, or preceded, by the assigning for at least one of said one or more categories a sharing status which allows diary events in said at least one category to be shared with at least a second electronic diary, operating on a second computing device. The sharing requires establishing of communication between the first electronic diary and the second electronic diary. The sharing step itself involves the sending of one or more diary events in said at least one category from the first electronic diary to the second electronic diary.

The mobile computing device (2) on receiving the communication from the computing device (4) (box (vi) of FIG. 7) unpackages the data (box (vii) of FIG. 7) and temporarily sets up an overlay (64) of its own display of the selected period with the display of the selected period received from the computing device (2) (box (viii) of FIG. 7). The overlay, in the above example would appear as a display on the screen (6) of the computing device (2) as shown in FIG. 6C (box (ix) of FIG. 7). The computing device (4) similarly sets up an overlay of its own display of the selected period with the display of the selected period received from the computing device (4), which would also be as shown in FIG. 6C. Each computing device (2, 4) could be arranged to show the time slots that are already taken up on their own display in a different colour or with a different type of shading from the time slots that are already taken up on the display of the other device. This is an example of different categories of information, in this case information associated with different users, being differently highlighted on a diary display.

In one aspect, the invention therefore provides a method of sharing diary events between electronic diaries in some ways of greater generality than for other aspects of the invention. This involves at some point creating a first electronic diary on a first computing device and creating a second electronic diary on a second computing device, and the forming of a collection of diary events on the first electronic diary as a representation of the first electronic diary. This can then be compared with the second electronic diary by establishing communication between the first electronic diary and the second electronic diary; and sending the representation of the first electronic diary from the first computing device to the second computing device for comparison with the second electronic diary.

The users could then discuss a potential meeting, each viewing the temporary overlay display on the screens (6, 8) of their own devices (2, 4) and then easily select a time slot that is free for both of them, for example, Friday morning from 09:00 to 11:00. In this way the event scheduling application according to the present invention, facilitates the arrangement of meetings. Once the meeting had been arranged the user of the device could manually input the details of the new appointment and the temporary diary overlay screen would be deleted (box (x) of FIG. 7). As an alternative, only one of the displays shown in FIGS. 6A and 6B could be shown at a time on the screens (6, 8) of the mobile devices (2, 4) and the users could toggle between the two displays to locate a convenient time to meet.

When sharing diary data in this way to arrange a meeting, privacy could be invaded if the detail of the appointments associated with the highlighted time slots are communicated to the other mobile device. This is avoided as described above by optionally communicating only highlighted time slots without communicating anything about the nature of the appointments associated with the highlighted time slots. This optional communication of details of appointments can be done automatically, as described above by associating each event with a category of information which is to be shared with only selected users.

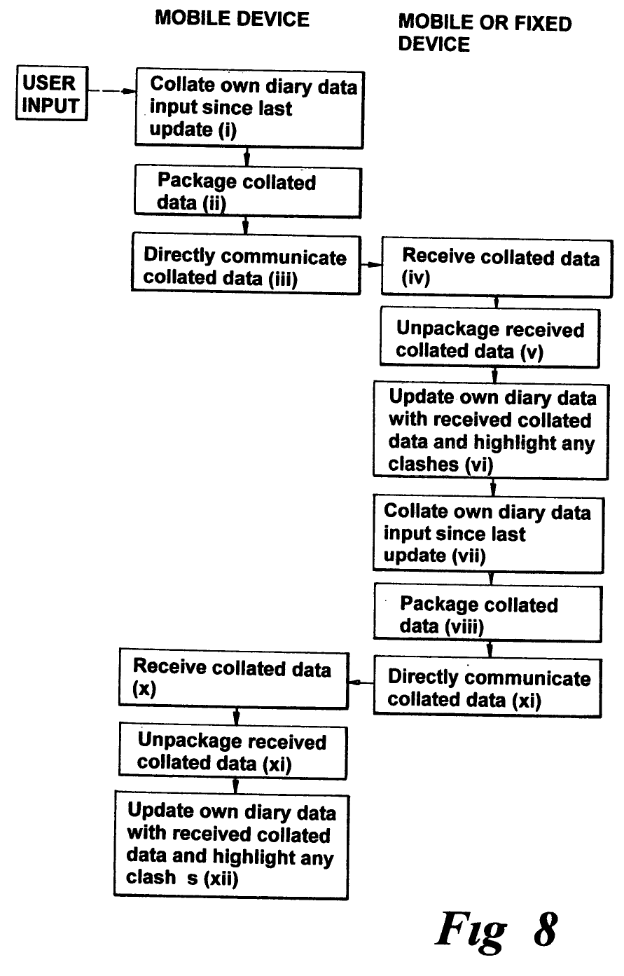

The event scheduling application according to the present invention can also be used to update the diary of the mobile device (2) with the diary of the mobile device (4), for example where the users of the mobile computing devices (2) and (4) are partners. In this case, the steps set out in the flow chart of FIG. 8 are followed. In accordance with FIG. 8, one of the mobile devices, for example device (2) would prepare a set of data including new entries into its diary since the last update with the device (4) (box (i) of FIG. 8). This data would then be packaged for transmission (box (ii) of FIG. 8) communicated directly to the other device, for example mobile device (4) in FIGS. 1A and 1B (box (iii) of FIG. 8) using, for example Bluetooth technology, and the other device (4) would use this data to update its own diary. The mobile device (4) would receive the diary data (box (iv) of FIG. 8), unpackage it (box (v) of FIG. 8) and then update its own diary (box (vi) of FIG. 8). The mobile device (4) could then prepare a set of data including new entries into its diary since the last update (box (vii) of FIG. 8), package this data (box (vii) of FIG. 8) and directly communicate it to the first mobile device (2) (box (ix) of FIG. 8). The first mobile device (2) would receive the diary data (box (x) of FIG. 8), unpackage it (box (xi) of FIG. 8) and update its own diary data with the received data (box (xii) of FIG. 8). The display generated on the screen (6, 8) of each of the mobile devices could show appointments for the husband in one colour or type of shading, appointments for the wife in a second colour or type of shading and appointments for both partners in a third colour or type of shading. Here again different categories of events, for example those associated with different users are highlighted differently on a diary display.

Again, when updating the diary data of other mobile devices, the details of specified categories of events can be deleted so that only the blocked time slot is communicated to the device of the other user.

When conducting the update, the event scheduling application of the mobile computing devices (2, 4) could be programmed to highlight any conflicting appointments (boxes (vi) and (xii) of FIG. 8) which have been made since the last update. If Bluetooth technology is used then the updating can be made to occur automatically, at predetermined time intervals and/or each time the partners move into the same vicinity.

The local radio frequency functionality of the Bluetooth technology is particularly appropriate for the direct communication between mobile computing devices because a group of people in the same vicinity, each with a Bluetooth enabled device and running the event scheduling application according to the present invention can be made to automatically and transparently connect and share the required data to implement the functionality of the present invention. The usefulness of diary sharing amongst a local group of mobile computing devices is greatly enhanced if there is interoperability between diverse types of devices from differing manufacturers. This can be achieved by adhering to industry approved standards, such as protocols for data communication and synchronisation and local wireless standards such as IrDA (Infrared Data Association) for infrared and Bluetooth for local radio frequency data exchange.

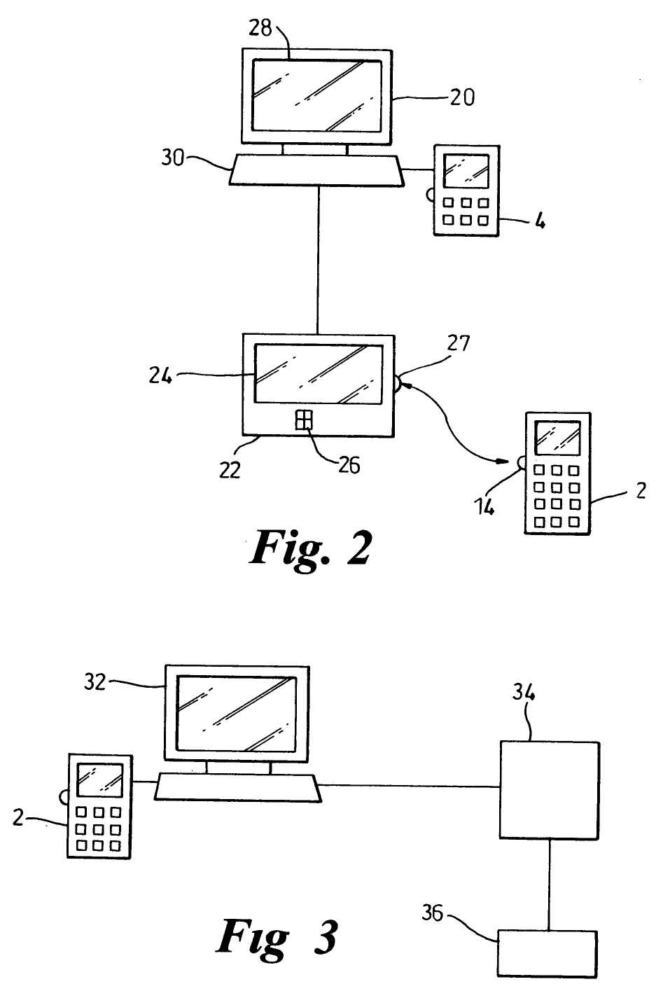

A further embodiment of the present invention is shown in FIG. 2 and comprises a fixed computing device, for example a personal computing device (20) based at home, a display device (22) which can be mounted in a prominent position within the home, for example on a wall in a communal area, and at least one mobile computing device (2, 4), of the type described above in relation to FIGS. 1A and 1B. Each of these devices run the event scheduling application according to the present invention. The mobile devices (2, 4) run an application as described above in relation to FIGS. 1A and 1B and so can communicate directly with other such devices to share diary data in order to schedule meetings or to update diaries, as described above in relation to FIGS. 7 and 8. The computing device (20) runs an application according to the present invention that additionally provides a central repository for the diary data contained in the mobile devices (2, 4). The display device (22) acts as a display for the central repository of diary data and is physically connected to the computing device (20). The display device (22) is preferably a very simple device comprising a thin liquid crystal display and only a few control buttons (26), for example for scrolling between different time periods, eg. weeks or months, of the diary data.

Each mobile device (2, 4) can be docked at the computing device (20), as shown for mobile device (4) in FIG. 2, by forming a physical connection between the computing device (20) and the mobile device (4). On docking the event scheduling application on the computing device (20) updates its central repository of diary data with data concerning new appointments input into the mobile device (2) since the last update with the computing device (20). The computing device (20) can also at this time update the diary data held by the mobile device (4) with appointments made on other mobile devices that are also periodically docked on the computing device (20). This update will utilise the steps shown in FIG. 8 and described above. During the update process any potential clashes of events can be highlighted for the users of the devices to address. This process is more generally known as “reconciliation”, and can be carried out according to conventional approaches for, say, synchronising data held in appplications running and updated on a PDA with data in applications also running and updated from a user's desktop computer.

Again, the event scheduling applications of the computing devices can be set up so that the details of specified categories of events are not transferred during the update so that only blocked time slots for those specified categories of events are transferred.

The data contained in the central repository of diary data of the computing device (20) is formatted into a diary display which can be shown on the screen (28) of the computing device (20). Entries of new appointments into the event scheduling application running on the computing device (20) can be input into the computing device, as for the mobile devices (2, 4) using the keyboard (30) of the computing device. These appointments will likewise be held as part of the central repository of diary data.

The diary display of the central repository of data held in the computing device (20) is communicated via a physical connection to the display device (22), for example each time the central depository is updated. The diary display is shown on a screen (24) of the display device (22). The display device (20) may be arranged only to show one week's worth of appointments at a time, and the weeks can be scrolled through, for example using the keyboard (26) on the display device (22). Again different categories of events, for example, events associated with different users, can be highlighted in different ways on the screen (24) of the display device (22).

The display device (22) can also incorporate a means of directly communicating with mobile devices (2, 4) in the vicinity of the display device. For example, the display device (22) may include a wireless transceiver unit (27) which uses wireless IrDA or Bluetooth technology to transfer diary data, as shown for mobile device (2) in FIG. 2. Alternatively, a physical connection could be used. This can provide a more convenient way for the mobile devices (2, 4) to dock with the computing device (20) to update diary data in the mobile device (2) and the computing device (20). The display device (22) and the mobile device (2) share diary data to update each other, as described above in relation to FIGS. 1A and 1B and FIG. 8 and any clashes are highlighted for the attention of the users of the devices (2, 22). Any new appointments communicated to the diary display (22) in this way are communicated via the physical connection to the computing device (20) which updates the central repository of diary data accordingly. Again specified categories of diary data can be transferred between computing devices with event details deleted.

Again, if Bluetooth technology is utilised to support wireless communication between mobile devices (2, 4) and the display device (22) in the system shown in FIG. 2, then the central repository of diary data and the display of this data on the display device (22) can be updated automatically each time the mobile computing devices (2, 4) enter the home. The display of the central repository of diary data shown in the screen of the display device (22) may highlight different people's appointments in different colours or different shading to facilitate the reading of the display.

Each mobile device (2, 4) that participates in the sharing of diary data as described above in relation to FIG. 2 can act in a peer to peer manner so that each device (2, 4) can share diary data with other similar devices, for example which it meets outside of the home. In order for this to be possible the software architecture on the computing device (20) must allow for the function of presenting available times to be delegated to the mobile devices (2, 4).

FIG. 3 shows a further embodiment of the present invention in which a mobile computing device (2), of the type described above in relation to FIGS. 1A, 1B and 2 can be docked to a fixed computing device (32), which is for example based at work, and which is connected via a local area network (LAN) (34) to a host server (36) which acts as a central repository for diary data for all computing devices connected to the LAN (34). The mobile device (2) would prepare a set of data including new entries into the event scheduling application since the last docking to the computing device (32) (box (i) of FIG. 8). This data would then be communicated via the LAN (34) to the host server (36) (boxes (ii) and (iii) of FIG. 8) which would use this data to update the central repository of diary data it stores (boxes (iv) to (vi) of FIG. 8). At the same time the host server (36) would communicate any diary data relevant to the user of the mobile device (2) which had been added to its central repository since the last docking of the mobile device (2) (boxes (vii) to (ix) of FIG. 8) and this data would be incorporated in the diary display of the mobile device (2) (boxes (x) to (xii) of FIG. 8). Again specified categories of diary data can be transferred between computing devices with event details deleted. When conducting the update, the event scheduling application running on the host server (36) could be programmed to highlight any conflicting appointments which have been made since the last docking to the user of the computing device (2) (boxes (vi) and (xii) of FIG. 8). At any time between docking at the computing device (32), the mobile device (2) may come into the vicinity of another such computing device and may share diary data with it, as described above in relation to FIGS. 1A and 1B above. In addition, the mobile device (2) may also be part of a system described in relation to FIG. 2 and so could also be regularly updated in relation to the central repository of data held in the computing device (20).

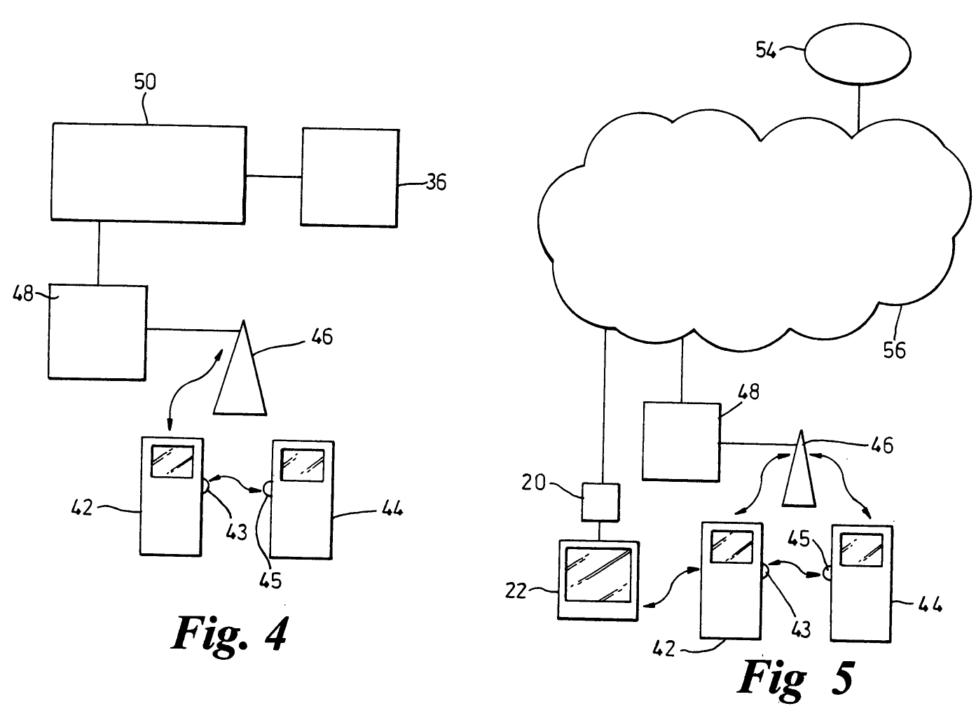

One problem that can arise in the embodiments discussed above, is that the diary data stored in a mobile device (2, 4) may not always be up to date, in that others may have scheduled an appointment involving the user of the device, for example on the computing device (20) of the FIG. 2 embodiment or on the host server (36) of the FIG. 3 embodiment, since the mobile device (2, 4) was last updated. This problem can be overcome, for example, where the mobile device is a mobile phone (42, 44), as shown in FIGS. 4 and 5. It is anticipated, for example, that most mobile phones will soon integrate Bluetooth transceiver modules. In this case the mobile phone (42, 44) which runs the event scheduling application according to the present invention can establish a link with a computing device (36, 54, 20) which acts as a repository for all the diary data for a group of associated users of such mobile devices (2, 4, 42, 44).

In FIG. 4, there is shown two mobile phones (42, 44) which each run an event scheduling application according to the present invention. The users of the mobile phones (42, 44) come face to face and decide either to schedule a meeting, as described above in relation to FIGS. 1A, 1B and 7. Alternatively, they may decide to update each other's diary with their diary data also as described above in relation to FIGS. 1A, 1B and 8. If the local communication link is a wireless link, then each mobile phone (42, 44) will comprise a respective wireless transceiver module (43, 45) for establishing the local communication link over which diary data is transferred between the mobile phones.

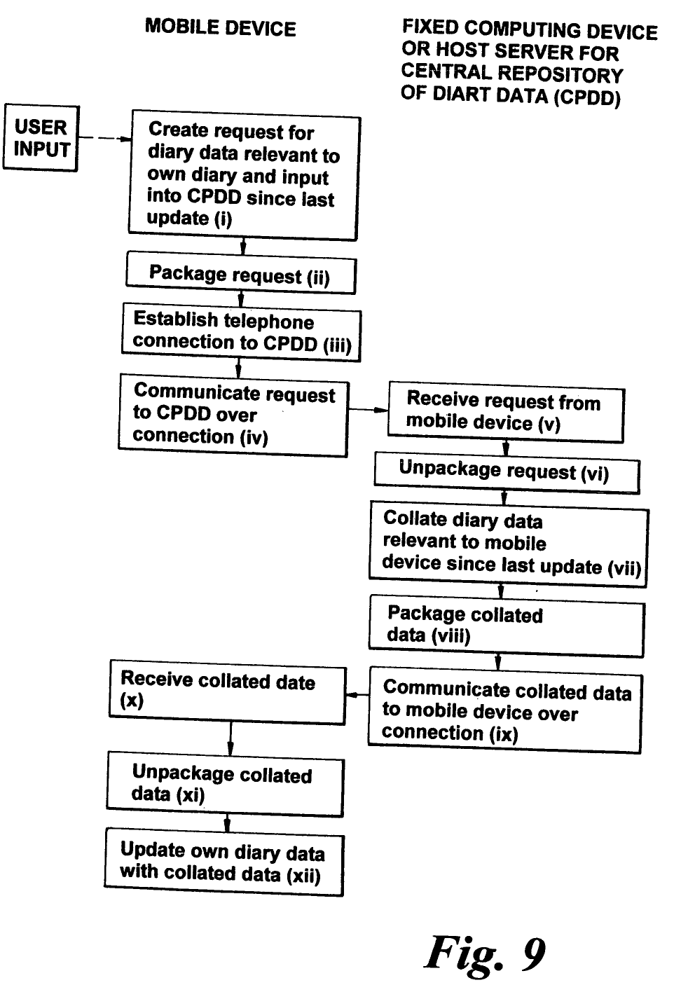

The mobile phone (42) is similar to the device (2) shown in FIG. 3 in that it is periodically connected to a host server (36) which it and a number of other mobile devices connect to, which host server (36) acts as a central repository for the diary data held within each of the mobile devices. Referring to mobile phone (42), before it directly communicates any diary data to mobile phone (44), it first communicates with the host server (36) to check that its diary data is up to date, following the steps set out in the flow chart of FIG. 9. To do this the mobile phone (42) creates a request for information relevant to its diary and input into the host server (36) since it was last updated (box (i) of FIG. 9) and packages the request for transmission (box (ii) of FIG. 9). The mobile phone then makes a telephone connection via a base station (46) of the mobile telecommunications network (48) which supports the mobile phone, and via an intermediate network, such as the PSTN (50) (public switched telephone network) to the host server (36) (box (iii) of FIG. 9). The mobile phone (42) communicates the request to the host server (36) for any diary data relevant to it which has been added to the central repository held by the host server (36) since the diary data stored in the mobile phone (42) was last updated (box (iv) of FIG. 9). The host server (36) receives the request (box (v) of FIG. 9), unpackages it (box (vi) of FIG. 9) and collates diary data which has been input into it since the mobile phone (42) was last updated and which involves the user of the mobile phone (42) (box (vii) of FIG. 9). The host server (36) then packages this data (box (viii) of FIG. 9) and sends it to the mobile phone (42) over the connection (box (ix) of FIG. 9). The mobile phone (42) receives the data from the host server (36) (box (x) of FIG. 9), unpackages it (box (xi) of FIG. 9) and then updates its own diary data accordingly (box (xii) of FIG. 9). The mobile phone (42) then proceeds to communicate the up to date diary data to the mobile phone (44).

The mobile phone (44) can likewise, check with any host server (36) or other 5 computing device which acts as a central repository for its relevant diary data before it communicates any diary data to the mobile phone (42), again using the steps set out in FIG. 9.

The system in FIG. 5 is similar to that shown in FIG. 2, except that in this embodiment the mobile devices (2, 4) are mobile phones (42, 44) which run the event scheduling application according to the present invention. Accordingly, the system shown in FIG. 5 includes a computing device (20) which acts as a repository for diary data for a set of mobile computing devices, for example belonging to a family, including the mobile phone (42). The diary data held on the computing device (20) is displayed on the display device (22) and the mobile phone (42) can be docked to the computing device (20) or directly connected to the display device for updating, as described above in relation to FIGS. 2 and 8. The mobile phone (44) is associated with a host server (54) which acts as a central repository for diary data relating to a group of mobile devices including the mobile phone (44).

The users of the mobile phones (42, 44) come face to face and decide to share diary data as described above in relation to mobile devices (2, 4) in FIGS. 1A and 1B. However, before communicating any diary data to the mobile phone (44) the mobile phone (42) sets up a connection with the computing device (20) via a base station (46) of a mobile telecommunications network (48) and the public Internet (56). The mobile phone (42) makes a request to the computing device (20) for any diary data relevant to it which has been added to the central repository held by the device (20) since the diary data stored in the mobile phone (42) was last updated. The computing device (20) sends the mobile phone (42) the requested data over the connection and the mobile phone (42) updates its diary data accordingly. The mobile phone (42) then proceeds to communicate the up to date diary data to the mobile phone (44). Again the mobile phone (42) follows the steps set out in FIG. 9 to update its diary data.

Similarly, before communicating any diary data to the mobile phone (42) the mobile phone (44) sets up a connection with the host server (54) via a base station (46) of a mobile telecommunications network (48) and the public Internet (56). The mobile phone (44) makes a request to the host server (54) for any diary data relevant to it which has been added to the central repository held by the host server (54) since the diary data stored in the mobile phone (44) was last updated. The host server (54) sends the mobile phone (44) the requested data over the connection and the mobile phone (44) updates its diary data accordingly. The mobile phone (42) then proceeds to communicate the up to date diary data to the mobile phone (44). Again the mobile phone (44) follows the steps set out in FIG. 9 to update its diary data.

In the embodiments of FIGS. 4 and 5, when a connection is made to the host server (36, 54) or computing device (20), this can be used as an opportunity for updating the central repository of diary data, with new appointments input to the mobile devices (42, 44) since they were last updated. Furthermore, if the connection is maintained until a new appointment is added to the diary data of the mobile phone (42, 44) or until the diary data of the mobile phone (42, 44) is updated with the diary data of the other mobile phone, then this provides an opportunity for details of these new appointments to be communicated to the central repository.

The display of diary data on the screens of the mobile devices (2, 4, 42, 44) and on the screen of the fixed computing devices (20, 32) and on the screen of the display device (22), may be an overlay. For example, diary data may be split 30 into different categories, each shown in a different diary display. The categories may include work appointments, leisure appointments, appointments of the user and appointments of different people with whom the user of the device is associated. Then when the user is viewing the diary he or she can scroll through the different diary displays. Alternatively the different diary displays could be overlaid to generate a composite diary display showing simultaneously more than one category of appointments at a time. This could be done automatically or the user could select at any time which categories of diary data are simultaneously displayed at any one time. The different overlaid diary displays could be differently highlighted, for example different categories of appointments could appear in different colours on the composite display or in different types of shading on the composite display. For example, a users diary data relating to his or her own appointments may result in a display shown in FIG. 6A (but with appointment text appearing in the shaded time slots). That user's diary data relating to his or her partner's diary data (which would be updated regularly as described above) may results in a display shown in FIG. 6B. The user may then select to have both partners' diary data simultaneously displayed on the screen of his or her device. In which case the displays of FIGS. 6A and 6B would be overlaid to generate a composite display of the type shown in FIG. 6C (but with appointment text appearing in the shaded time slots). This provides an easy way of viewing diary data relating to different categories of appointment and to different people's appointments.

1. A computing device programmed with a diary system application, the computing device comprising a processor, a memory, a user interface and a communications interface, wherein the processor running the diary system application allows a user to assign through the user interface one or more diary events stored in the memory to one or more categories; and wherein the processor running the diary system application allows or disallows communication to other devices through the communication interface of diary events on the basis of the category or categories to which the diary events have been assigned.

2. A computing device as claimed in claim 1, wherein the processor running the diary system application is programmed to enable all diary events in one or more of said categories to be sent together through the communications interface as a representation of a user diary.

3. A computing device as claimed in claim 1 or claim 2, wherein the computing device is portable and adapted for handheld use.

4. A computing device as claimed in claim 3, wherein the computing device is adapted for communication with a further computing device programmed with a copy of the diary application, and wherein the processor running the diary system application is programmed to allow reconciliation of a user diary between the computing device and the further computing device.

5. A computing device as claimed in claim 3 or claim 4, wherein the communications interface comprises a short range wireless transceiver, and wherein the wherein the processor running the diary system application is programmed to allow diary events to be communicated to a proximate computing device through the short range wireless transceiver.

6. A computing device as claimed in any of claims 1 to 4, wherein the user is able to designate one or more other devices as allowed or not allowed to receive diary events in one or more categories, and wherein the processor running the diary system application allows or disallows communication to such designated devices through the communication interface of diary events in said one or more of said categories.

7. A computing device as claimed in claim 6, wherein the processor running the diary application is programmed to authenticate a designated device before providing diary events to such designated devices.

8. A computing device as claimed in any preceding claim and further comprising a display, wherein the processor running the diary application is programmed to receive a representation of a remote diary comprising diary events in one or more categories, and to display the representation on the display.

9. A computing device as claimed in claim 8, wherein the representation of the remote diary is displayed together with a user diary stored in the memory.

10. A computing device as claimed in claim 9, wherein the representation is displayed as an overlay.

11. A computing device as claimed in claim 8, wherein the representation shows only the presence or absence of diary events for any point of time covered by the representation.

12. A computing device as claimed in any of claims 8 to 11, wherein the representation is stored temporarily in the memory for comparison with a diary stored in the memory and wherein the processor running the diary application deletes the representation from memory after completing the comparision.

13. A computing device as claimed in any preceding claim, wherein for one or more categories there is assigned a sharing status in which only a part of the information relating to the diary events in that category is allowed to be communicated to other devices.

14. A computing device as claimed in claim 13, wherein the part of the information to be sent for such a diary event is the existence of the diary event and its start time and finish time or duration.

15. A portable computing device programmed with a diary system application, the computing device comprising a processor, a memory, a user interface, a display and a wireless transmitter adapted for short range communication, wherein the processor running the diary system application allows a user to view a user diary on the display, assign through the user interface one or more diary events stored in the memory to one or more categories; and wherein the processor running the diary system application allows or disallows communication to other devices through the wireless transceiver of diary events in one or more of said categories on the basis of the category or categories to which the diary events have been assigned.

16. A portable computing device as claimed in claim 15, wherein said wireless transmitter is a radio transmitter.

17. A portable computing device as claimed in claim 15, wherein said wireless transmitter is an infra-red transmitter.

18. A portable computing device as claimed in any of claims 15 to 17, further comprising a wireless receiver and wherein the processor running the diary application is programmed to receive through the wireless receiver a representation of a remote user diary comprising diary events in one or more categories, and to display the representation on the display.

19. A computing device as claimed in claim 18, wherein the representation of the remote user diary is displayed together with a diary stored in the memory.

20. A method of sharing diary events between electronic diaries, comprising:
assigning one or more diary events stored in a first electronic diary, operating on a first computing device, to one or more categories;
assigning for at least one of said one or more categories a sharing status which allows diary events in said at least one category to be shared with at least a second electronic diary, operating on a second computing device;
establishing communication between the first electronic diary and the second electronic diary; and
sending one or more diary events in said at least one category from the first electronic diary to the second electronic diary.

21. A method of sharing diary events as claimed in claim 20, wherein said step of sending one or more diary events comprises sending all diary events in each of one or more categories as a representation of a user diary.

22. A method of sharing diary events as claimed in claim 20 or claim 21, wherein one or both of the first and second computing devices is a portable computing device, and wherein the step of sending one or more diary events comprises sending from a short range wireless transmitter in the first computing device to a wireless receiver in the second computing device.

23. A method of sharing diary events as claimed in claim 22, wherein the short range wireless transmitter is a low power radio transmitter and the wireless receiver is a radio receiver.

24. A method of sharing diary events as claimed in claim 22, wherein the short range wireless transmitter is an infra-red transmitter and the wireless receiver is an infra-red receiver.

25. A method of sharing diary events as claimed in any of claims 20 to 24, wherein the step of assigning a sharing status comprises assigning for one or more categories specific users or devices as allowed to receive diary events in that or those categories.

26. A method of sharing diary events as claimed in claim 25, wherein said step of establishing communication further comprises the first computing device establishing an identity of either the second computing device or of a user of the second computing device.

27. A method of sharing diary events as claimed in any of claims 20 to 26, further comprising the step of:
displaying the diary events from the first electronic diary on a display of the second computing device.

28. A method of sharing diary events as claimed in claim 27, wherein the step of displaying comprises showing the diary events from the first electronic diary together with diary events from the second electronic diary.

29. A method of sharing diary events as claimed in claim 27, wherein the diary events from the first electronic diary are shown as an overlay over the second electronic diary.

30. A method of sharing diary events as claimed in any of claims 27 to 29, wherein the diary events from the first electronic diary are stored temporarily in the second computing device for comparison with the second electronic diary and are deleted from the second computing device after the comparison is completed.

31. A method of sharing diary events as claimed in any of claims 20 to 30, wherein the step of assigning a sharing status comprises assigning for one or more categories a sharing status in which only a part of the information relating to the diary events in that category is to be sent to the second electronic diary.

32. A method of sharing diary events as claimed in claim 31, wherein the part of the information to be sent for such a diary event is the existence of the diary event and its start time and finish time or duration.

33. A method of sharing diary events between electronic diaries, comprising:
creating a first electronic diary on a first computing device;
creating a second electronic diary on a second computing device;
forming a collection of diary events on the first electronic diary as a representation of the first electronic diary;
establishing communication between the first electronic diary and the second electronic diary; and
sending the representation of the first electronic diary from the first computing device to the second computing device for comparison with the second electronic diary.

34. A method of sharing diary events as claimed in claim 33, wherein the representation of the first electronic diary is stored temporarily on the second computing device and is deleted when the comparison with the second electronic diary is completed.

35. A method of sharing diary events as claimed in claim 33 or claim 34 in which only a part of the information relating to diary events in the collection of diary events is sent to the second computing device.

36. A method of sharing diary events as claimed in claim 35, wherein the part of the information to be sent for such a diary event is the existence of the diary event and its start time and finish time or duration.

37. A method of sharing diary events as claimed in any of claims 33 to 36, wherein the diary events from the first electronic diary are shown as an overlay over the second electronic diary.

38. A computer program product on a data carrier, a processor programmed with the computer program product having the following functions:
maintaining a user diary comprising a plurality of diary events;
enabling diary events to be assigned to one or more sharing categories, each sharing category having a sharing status; and
sharing the diary events in said one or more sharing categories in accordance with the sharing status of that sharing category.

39. A computer program product as claimed in claim 38, wherein one possible sharing status is restriction to designated users or devices.
